(19) United States
(12) Patent Application Publication
(10) Pub. No.: US 2011/0097089 A1
(43) Pub. Date: Apr. 28, 2011

(54) TRANS-SPECTRAL COMMUNICATIONS DEVICE

(76) Inventor: Jeffrey H. Hunt, Thousand Oaks, CA (US)

(21) Appl. No.: 12/607,425

(22) Filed: Oct. 28, 2009

(51) Int. Cl. H04B 10/00

(52) U.S. Cl. 398/115

(57) ABSTRACT

A communications device for receiving and transmitting signals at multiple wavelengths may include a combination optical telescope and RF receiver/transmitter for receiving and transmitting signals at multiple wavelengths. The communications device may also include a nonlinear mixing medium coupled to the combination optical telescope and RF receiver/transmitter. The nonlinear mixing medium may be adapted to switch between optical carrier frequency ranges without detecting and retransmitting a received signal.

### FIELD

The present disclosure relates to communications and communications systems, and more particularly to a trans-spectral communications device and method for receiving and transmitting signals at multiple wavelengths useable in a networked communications system.

### BACKGROUND

Evolving network centric communications systems are expected to have very high transmission data rates. These transmission data rates may typically be in the multiple gigabits per second (Gb/s) bandwidth range. Moving between the different spectral regions, frequency ranges or wavelengths to find the optimum spectral selection may prove to be challenging. Temporal bottlenecks may result caused by electronic processing (detection and retransmission) associated with moving or transitioning from one spectral band to another, e.g., moving from radio frequency (RF) to microwave to terahertz (THz) to optical carrier regimes. Heritage systems used throughout the aerospace and defense communities are based on communications devices that generate and detect only within a given spectral band. Bandwidths cannot be pushed much higher than carrier frequencies. Without the ability to move easily from one carrier band to another, temporal transmission latencies will occur if there is a need to change carriers. This will make communications or other network operations, such as geographically distributed computation, networked sensing and similar operations unfeasible.

### SUMMARY

In accordance with an embodiment, a communications device for receiving and transmitting signals at multiple wavelengths may include a combination optical telescope and RF receiver/transmitter for receiving and transmitting signals at multiple wavelengths. The communications device may also include a nonlinear mixing medium coupled to the combination optical telescope and RF receiver/transmitter. The nonlinear mixing medium may be adapted to switch between optical carrier frequency ranges without detecting and retransmitting a received signal.

In accordance with another embodiment, a networked communications system may include a communications node to establish a communications link between a plurality of other communications elements of the networked communications system. The communications node may include a combination optical telescope and RF receiver/transmitter for receiving and transmitting optical signals and RF signals. The communications node may also include a nonlinear mixing medium coupled to the combination optical telescope and RF receiver/transmitter. The nonlinear mixing medium may be adapted to switch between optical carrier frequency ranges without detecting and retransmitting a received signal.

In accordance with another embodiment, a method to transmit and receive signals at multiple wavelengths may include collecting electromagnetic radiation at an optical regime. The method may also include switching between optical carrier frequency ranges without detecting and retransmitting a received signal.

Other aspects and features of the present disclosure, as defined solely by the claims, will become apparent to those ordinarily skilled in the art upon review of the following non-limited detailed description of the disclosure in conjunction with the accompanying figures.

### BRIEF DESCRIPTION OF THE SEVERAL VIEWS OF THE DRAWINGS

The following detailed description of embodiments refers to the accompanying drawings, which illustrate specific embodiments of the disclosure. Other embodiments having different structures and operations do not depart from the scope of the present disclosure.

FIG. 1 is a block schematic diagram of an example of a communications device for receiving and transmitting signals at multiple wavelengths in accordance with an embodiment of the present disclosure.

FIG. 2 is an example of a method for receiving and transmitting signals at multiple wavelengths in accordance with an embodiment of the present disclosure.

FIG. 3 is a block diagram of an example of networked communications system in accordance with an embodiment of the present disclosure.

### DESCRIPTION

The following detailed description of embodiments refers to the accompanying drawings, which illustrate specific embodiments of the disclosure. Other embodiments having different structures and operations do not depart from the scope of the present disclosure.

As will be appreciated by one of skill in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

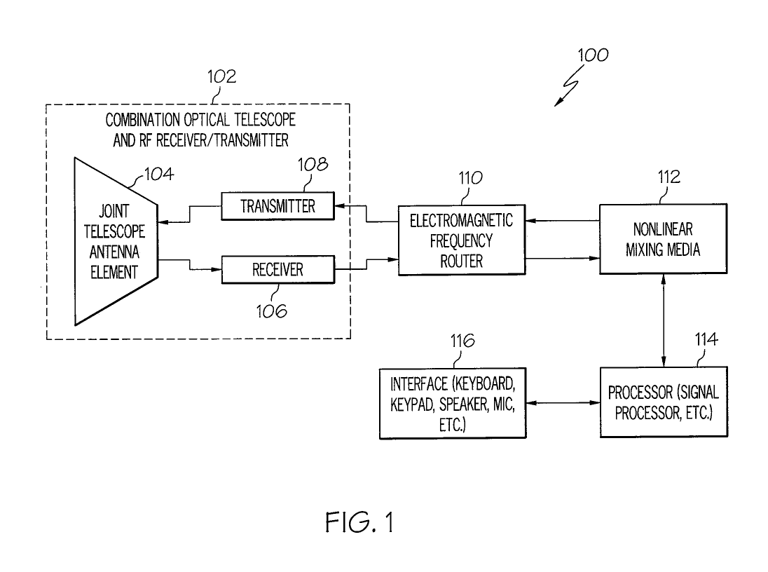

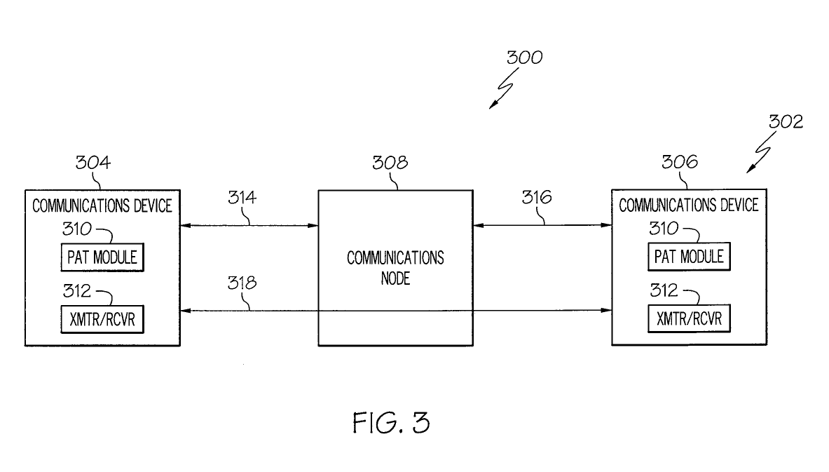

FIG. 1 is a block schematic diagram of an example of a trans-spectral communications device 100 capable of receiving and transmitting signals at multiple wavelengths in accordance with an embodiment of the present disclosure. The communications device 100 may be used as a communications node or communications link in a networked communications system. An example of such a networked communications system 300 will be described in more detail with reference to FIG. 3.

The communications device 100 may include a combination optical telescope and radio frequency (RF) receiver/transmitter 102. The combination optical telescope and RF receiver/transmitter 102 may be adapted to receive and transmit signals at multiple wavelengths. Accordingly, the combination optical telescope and RF receiver/transmitter may include a joint telescope antenna element 104. The joint telescope antenna element 104 may be coupled to a RF receiver 106 for receiving and processing RF signals, and the joint telescope antenna element 104 may also be coupled to a RF transmitter 108 for processing and transmitting RF signals to the joint telescope antenna element 104 for transmission at the multiple wavelengths. The combination optical telescope and RF receiver/transmitter 102 is adapted to reduce a physical spot size of the received optical signal by a predetermined magnification to provide a chosen spot size. The spot size will be determined by a number of geometric factors associated with the receiver control electronics. If optical, the signal will typically be coupled into an optical fiber for amplification in anticipation of further computational processing. Optical fiber inputs used for communications will have diameters on the order of about 10 microns, so that spot sizes will have to be on the same order. With longer wavelengths, RF signals will have spot sizes on the order of many centimeters. However, wavelength aside and actual hardware aside, the handling of the radiation will be the same in both cases. That is, as much of the radiation as possible is captured in the “spot,” amplify it to a point where the receiver electronics can process the signal. A combination telescope will accommodate the many orders of magnitude range in spot size.

The combination optical telescope and RF receiver/transmitter 102 may be coupled to an electronic frequency router 110. The router 110 may be a passive or active element. Passive devices will be elements akin to diffraction gratings, etalons, prisms, or any other material which uses its innate refractive index dispersion to physically separate the carrier frequencies from one another. Active devices may be those whose refractive index is altered by application of an external physical effect, such as an electric field, with the subsequent refractive index modification leading to a separation in the frequencies.

The electromagnetic frequency router 110 may be coupled to a nonlinear mixing medium or media 112. The nonlinear mixing media 112 may be adapted to switch between optical carrier ranges without detecting and retransmitting a received signal. The nonlinear mixing media 112 may be adapted change a carrier of a received optical signal for carrying information and to change a carrier of a RF signal for transmission by the combination optical telescope and RF receiver/transmitter 102.

Thus, the optical telescope 104 of the combination optical telescope and RF receiver/transmitter 102 may collect electromagnetic radiation at an optical regime or at an optical frequency and wavelength. Without detecting and retransmitting the electromagnetic radiation, the collected electromagnetic radiation at the optical regime is passed by the electromagnetic frequency router 110 to the nonlinear mixing media 112. The nonlinear mixing media 112 is then configured or adapted to nonlinearly optically shift the electromagnetic radiation at the optical regime to the RF regime of the electromagnetic spectrum. Detecting the electromagnetic radiation may be defined herein as changing an information carrying medium from an optical medium to an electron-based carrying medium by physical interaction and retransmission of a signal in the RF regime. Accordingly, the optical electromagnetic radiation received is not changed by physical interaction and retransmission of a signal in the RF regime. The electromagnetic radiation at the optical regime may undergo optical rectification by the nonlinear mixing media 112 to create the RF signal. This is distinct from present systems, where a detector must absorb the radiation, use electrical and electronic systems to connect to a transmitter suitable for operation at another frequency. The system here is called all optical, that is, the radiation goes through a “black box” is acted upon by an external media, changes its electromagnetic properties and exits the black box still as electromagnetic radiation.

The nonlinear mixing media 112 may further be adapted or configured to modulate an optical carrier using a RF modulated signal for transmission of information carried by the RF modulated signal by the optical telescope 104.

The nonlinear mixing media 112 may be further adapted or configured to move or transition a RF signal to a terahertz (THz) portion of the electromagnetic frequency spectrum for transmission by the optical telescope 104. The nonlinear mixing media 112 may downconvert an optical carrier to the THz regime of the electromagnetic frequency spectrum.

Examples of devices that may be used for the nonlinear mixing media 112 may include a nonlinear optical crystal, such as a DAST crystal or the like, a THz wave generator or similar devices capable of performing the operations and functions described herein. Examples of such devices are described in: “Difference-Frequency Terahertz-Wave Generation from 4-Dimethylamino-N-Methyl-4-Stilbazolium-Tosylate by Use of an Electronically Tuned Ti:Sapphire Laser” by Kawase, K. et al., Optics Letters, Vol. 24, No. 15, pp. 1065-1067 (Aug. 1, 1999); “Tunable Terahertz Wave Generation in the 3- to 7-THz Region from GaP” by Tanabe, T. et al., Applied Physics Letters, Vol. 83, No. 2, pp. 237-239 (Jul. 14, 2003); “Widely Tunable Terahertz-Wave Generation in an Organic Crystal and Its Spectroscopic Application” by Taniuchi, T. et al., Journal of Applied Physics, Vol. 95, No. 11, pp. 5984-5988 (Jun. 1, 2004); and “Efficient, Tunable, and Coherent 0.18-5.27-THz Source Based on GaSe Crystal” by Shi Wei et al., Optics Letters, Vol. 27, No. 16, pp. 1454-1456 (Aug. 15, 2002).

The communications device 100 may also include a processor 114 and a user interface 116. The processor 114 may be coupled to the nonlinear mixing media 112 to process any signals from the nonlinear mixing media 112 for presentation to a user via the user interface 116. Similarly, the processor 114 may process any input signals from the interface 116 to put the input signals in proper form for the non-linear mixing media 112. The processor 114 may be a signal processor or similar apparatus. The interface 116 may include a keyboard or keypad, a microphone, a speaker or any other apparatus to permit a user to interface with the communications device 100.

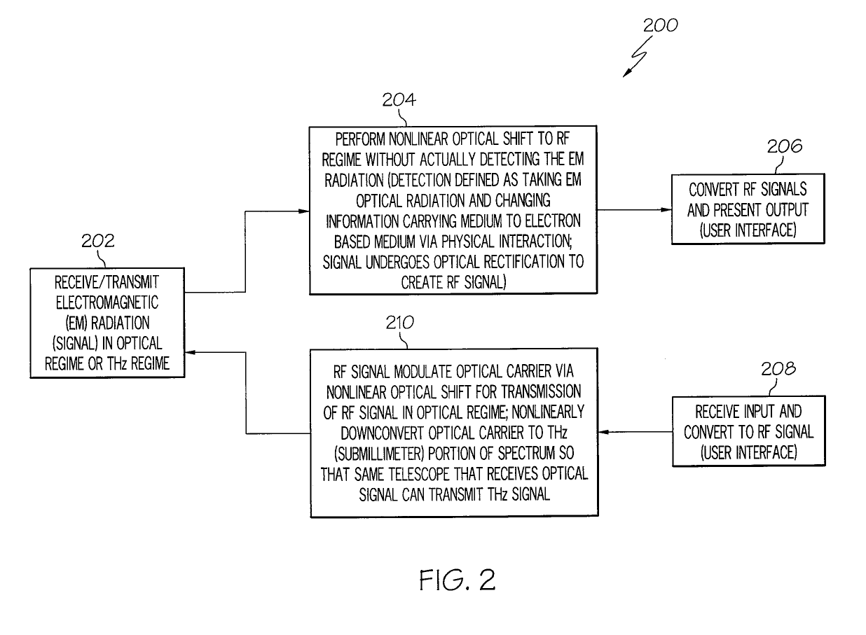

FIG. 2 is an example of a method 200 for receiving and transmitting signals at multiple wavelengths in accordance with an embodiment of the present disclosure. The method 200 may be embodied in the communications device 100 of FIG. 1. In block 202, electromagnetic radiation, a signal or signals may be received in the optical regime of the frequency spectrum.

In block 204, a nonlinear optical shift from the optical regime to the RF regime may be performed on the optical electromagnetic radiation or signal without actually detecting the optical electromagnetic radiation. The signal may undergo optical rectification to create a RF signal. In other words the optical carrying medium may be converted to an electron-based medium without physical interaction to the signal.

In block 206, the RF signal may be converted to an output signal intelligible by a user, for example an audio and/or video signal or output presentable on a display. The output may be presented to a user via a user interface. The user interface may similar to user interface 114 of FIG. 1.

In block 208, an input may be received via the user interface. The input may be converted to a RF signal. In block 210, the RF signal may modulate an optical carrier by way of a nonlinear optical shift of the RF signal for transmission of the information in the RF signal in the optical regime of the frequency spectrum. The optical carrier may be nonlinearly downconverted, such as in a nonlinear mixing media 112 in FIG. 1, to the THz (submillimeter) portion of the frequency spectrum so that an optical telescope, such as optical telescope 104 in FIG. 1, may transmit the THz signal.

In block 202, the electromagnetic radiation from block 210 may be transmitted in the optical regime.

FIG. 3 is a block diagram of an example of networked communications system 300 in accordance with an embodiment of the present disclosure. The networked communications system 300 may include a plurality of communications elements 302. The plurality of communications elements 302 may include communications devices 304 and 306 and communications nodes or links, such as communications node or link 308. An example of a networked communications system is described and claimed in U.S. patent application Ser. No. 12/607,227 (Attorney Docket No. 09-0615.107) entitled “Pointing, Acquisition and Tracking in a Networked Communications System” by the same inventor as the present application and filed on the same date as the present application, and is incorporated herein in its entirety by reference.

Each of the communications devices 304 and 306 may include a pointing, acquisition and tracking (PAT) module 310, and a transmitter/receiver 312. The transmitter/receiver 312 is shown as a common component in FIG. 3 but may also be separate components.

The communications node 308 or link may be the same or similar to the communications device 100 in FIG. 1. The communications devices 304 and 306 may also be similar to the communications device 100 in FIG. 1.

Similar to that described in U.S. patent application Ser. No. 12/607,227 (Attorney Docket No. 09-0615.107) entitled “Pointing, and Tracking in a Networked Communications System”, a first PAT link 314 may be established between the first communications device 304 and the communications node or link 308. A second PAT link 316 may be established between the second communications device 306 and the communications node 308. A third PAT link 318 may be established between the first communications device 304 and the second communications device 306 through the communications node or link 308. If any of the PAT or communications links 314, 316, and 318 are lost or fail for any reason, such as loss of line of sight optical communications, information or data associated with the other two links may be used to re-establish the lost communications link, similar to that described in U.S. patent application Ser. No. 12/607,227 (Attorney Docket No. 09-0615.107).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the embodiments herein have other applications in other environments. This application is intended to cover any adaptations or variations of the present disclosure. The following claims are in no way intended to limit the scope of the disclosure to the specific embodiments described herein.

What is claimed is:

1. A communications device for receiving and transmitting signals at multiple wavelengths, comprising:
a combination optical telescope and RF receiver/transmitter for receiving and transmitting signals at multiple wavelengths; and
a nonlinear mixing medium coupled to the combination optical telescope and RF receiver/transmitter, the nonlinear mixing medium being adapted to switch between optical carrier frequency ranges without detecting and retransmitting a received signal.

2. The communications device of claim 1, wherein the nonlinear mixing medium is adapted to change a carrier of a received optical signal for carrying information and to change a carrier of a RF signal for transmission by the combination optical telescope and RF receiver/transmitter.

3. The communications device of claim 1, wherein the combination optical telescope and RF receiver/transmitter is adapted to reduce a physical spot size of the received optical signal by a predetermined magnification to provide a chosen spot size.

4. The communications device of claim 1, wherein the optical telescope of the combination optical telescope and RF receiver/transmitter is adapted to collect electromagnetic radiation at an optical regime, and without detecting the electromagnetic radiation, the nonlinear mixing medium is adapted to nonlinearly optically shift the electromagnetic radiation at the optical regime to the RF regime of the electromagnetic spectrum.

5. The communications device of claim 4, wherein the electromagnetic radiation at the optical regime undergoes optical rectification by the nonlinear mixing medium to create a RF signal.

6. The communications device of claim 4, wherein detecting the electromagnetic radiation is defined as changing an information carrying medium from an optical medium to an electron based carrying medium by physical interaction and retransmission of a signal in the RF regime.

7. The communications device of claim 1, wherein the nonlinear mixing medium is adapted to modulate an optical carrier using a RF modulating signal for transmission of information carried by the RF modulating signal by the optical telescope of the combination optical telescope and RF receiver/transmitter.

8. The communications device of claim 1, wherein the nonlinear mixing medium is adapted to move a RF signal for transmission to a terahertz portion of an electromagnetic frequency spectrum for transmission by the optical telescope of the combination optical telescope and RF receiver/transmitter.

9. The communication device of claim 8, the nonlinear mixing medium is adapted to nonlinearly downconvert an optical carrier to the terahertz regime of the electromagnetic frequency spectrum.

10. The communication device of claim 1, further comprising an electromagnetic frequency router coupled between the combination optical telescope and RF receiver/transmitter.

11. The communications device of claim 1, wherein the nonlinear mixing medium comprises a nonlinear optical crystal.

12. The communications device of claim 1, wherein the nonlinear mixing medium comprises a terahertz wave generator.

13. A networked communications system, comprising:
a communications node to establish a communications link between a plurality of other communications elements of the networked communications system, the communications node comprising:
a combination optical telescope and RF receiver/transmitter for receiving and transmitting optical signals and RF signals; and
a nonlinear mixing medium coupled to the combination optical telescope and RF receiver/transmitter, the nonlinear mixing medium being adapted to switch between optical carrier frequency ranges without detecting and retransmitting a received signal.

14. The networked communications system of claim 13, wherein the optical telescope of the combination optical telescope and RF receiver/transmitter is adapted to collect electromagnetic radiation at an optical regime, and without detecting the electromagnetic radiation, the nonlinear mixing medium is adapted to nonlinearly optically shift the electromagnetic radiation at the optical regime to the RF regime of the electromagnetic spectrum.

15. The networked communications system of claim 14, wherein the electromagnetic radiation at the optical regime undergoes optical rectification by the nonlinear mixing medium to create a RF signal.

16. The networked communications system of claim 13, wherein the nonlinear mixing medium is adapted to modulate an optical carrier using a RF modulating signal for transmission of information carried by the RF modulating signal by the optical telescope of the combination optical telescope and RF receiver/transmitter.

17. A method to transmit and receive signals at multiple wavelengths, comprising:
collecting electromagnetic radiation at an optical regime; and
switching between optical carrier frequency ranges without detecting and retransmitting a received signal.

18. The method of claim 17, further comprising shifting the electromagnetic radiation at the optical regime nonlinearly and optically to the RF regime of the electromagnetic spectrum.

19. The method of claim 17, modulating an optical carrier using a RF modulating signal for transmission of information carried by the RF modulating signal by an optical telescope.

20. The method of claim 17, transitioning a RF signal for transmission to a terahertz portion of an electromagnetic frequency spectrum for transmission by an optical telescope.
